(19) United States
(12) Patent Application Publication
(10) Pub. No.: US 2025/0277692 A1
(43) Pub. Date: Sep. 4, 2025

(54) ENVIRONMENTAL PERCEPTION USING DISTRIBUTED OPTICAL FIBER SENSING: RAIN INTENSITY MONITORING BY DEEP FREQUENCY FILTERING

(71) Applicant: NEC Laboratories America, Inc., Princeton, NJ (US)

(72) Inventors: Zhuocheng JIANG, Plainsboro, NJ (US); Yue TIAN, Princeton, NJ (US); Yangmin DING, East Brunswick, NJ (US); Sarper OZHARAR, Pennington, NJ (US); Ting WANG, West Windsor, NJ (US)

(73) Assignee: NEC Laboratories America, Inc., Princeton, NJ (US)

(21) Appl. No.: 19/069,329

(22) Filed: Mar. 4, 2025

Related U.S. Application Data
(60) Provisional application No. 63/560,872, filed on Mar. 4, 2024.

(51) Int. Cl. G01H 9/00; G01W 1/14

(52) U.S. Cl. CPC G01H 9/004; G01W 1/14

(57) ABSTRACT

Disclosed are integrated DFOS/DAS systems, methods, and structures that advantageously enhances rainfall sensing by employing a Deep Phase-Magnitude Network (DFMN), dividing raw DFOS sensing data into phase and magnitude components, and performing targeted feature learning on each component independently. The disclosed systems, methods, and structures employ a Phase Frequency learnable filter (PFLF) for phase component filtering and utilize standard convolution layers on the magnitude component, advantageously leveraging inherent physical properties of optical fiber sensing. Finally, a phase-magnitude channel is formulated in a parallel network and subsequently fuses the features for a comprehensive analysis. Experimental results on collected fiber sensing data show that our systems and method according to aspects of the present disclosure perform favorably as compared with alternative, state-of-the-art approaches.

### CROSS-REFERENCE TO RELATED APPLICATIONS

This application claims the benefit of U.S. Provisional Patent Application Ser. No. 63/560,872 filed Mar. 4, 2024, the entire contents of which is incorporated by reference as if set forth at length herein.

### FIELD OF THE INVENTION

This application relates generally to weather monitoring using distributed fiber optic sensing (DFOS). More particularly, it pertains to environmental perception/rain intensity monitoring using DFOS and deep frequency filtering.

### BACKGROUND OF THE INVENTION

Distributed Acoustic Sensing (DAS) is a DFOS technology that uses fiber optic cables to detect acoustic vibrations. It has a wide range of applications due to its unique capabilities. Its ability to detect small vibrations over long distances in real-time makes it a valuable tool for monitoring and protecting the environment

The ability to detect rainfall and rainfall intensity in real-time is of critical importance to the operations of contemporary society. Currently, the detection of rainfall and rainfall intensity depends primarily on land-based weather stations and Earth-orbiting satellites. However, these methods are subject to limitations in terms of availability and accessibility. As climate change leads to more frequent and more intense precipitation events, there is an urgent need for improved methods to measure—in real-time—rainfall and rainfall intensity accurately. Such urgency highlights an imperative to innovate and develop sensors that are capable of long-range, wide-coverage rainfall and rainfall intensity.

### SUMMARY OF THE INVENTION

An advance in the art is made according to aspects of the present disclosure directed to integrated DFOS/DAS systems, methods, and structures that advantageously—and in sharp contrast to the prior art—enhances rainfall sensing by introducing a Deep Phase-Magnitude Network (DFMN), dividing raw DFOS sensing data into phase and magnitude components, and performing targeted feature learning on each component independently.

In further contrast to the prior art, our inventive systems, methods, and structures employ a Phase Frequency learnable filter (PFLF) for phase component filtering and utilize standard convolution layers on the magnitude component, advantageously leveraging inherent physical properties of optical fiber sensing. Finally, a phase-magnitude channel is formulated in a parallel network and subsequently fuses the features for a comprehensive analysis. Experimental results on collected fiber sensing data show that our method according to aspects of the present disclosure performs favorably as compared with alternative, state-of-the-art approaches.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing illustrative overview of our Deep Phase-Magnitude Network (DPMN) according to aspects of the present disclosure.

FIG. 3 is a schematic diagram showing illustrative implementation details of our inventive systems, methods, and structures according to aspects of the present disclosure.

FIG. 4 shows in tabular form a comparison of our inventive Phase Frequency Learnable Filtering (PFLF) module with baseline ResNet and other frequency filtering solutions according to aspects of the present invention.

FIG. 5(A), FIG. 5(B), FIG. 5(C), FIG. 5(D), FIG. 5(E), FIG. 5(F), FIG. 5(G), and FIG. 5(H) show a series of plots for the comparisons of FIG. 4 according to aspects of the present disclosure.

FIG. 6 shows in tabular form illustrative effectiveness of our inventive DPMN model, the results of classification and domain generalization according to aspects of the present invention.

FIG. 7 is a schematic diagram showing illustrative features of systems, methods, and structures according to aspects of the present disclosure.

FIG. 8 is a schematic diagram showing illustrative computer system in which methods of the instant disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

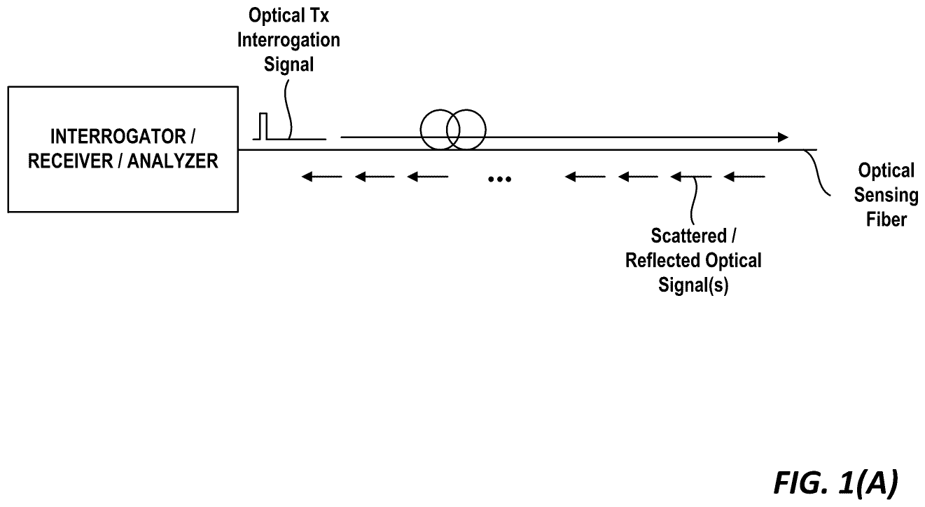

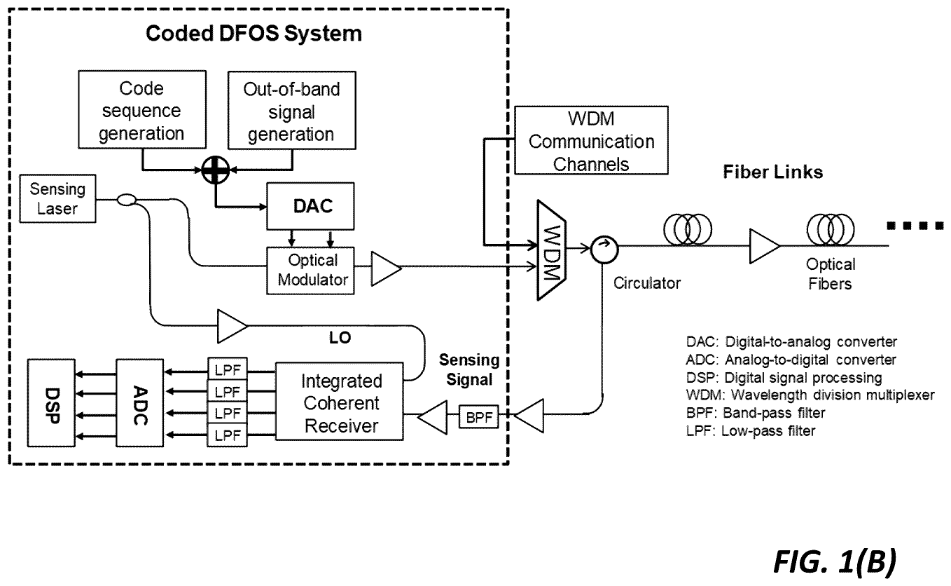

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As is known, acoustic signals are produced by numerous events, enabling humans to naturally learn various types of sounds through acoustic sensory experiences. Therefore, acoustic signals are one of the essential factors for real-time awareness of surrounding events, as well as image and video data.

For example, the detection of an explosion sound by our ears can immediately indicate an anomaly. Deploying numerous audio sensors, like electric microphones, over large areas can provide valuable acoustic information for anomaly detection and scene or event recognition. However, this approach is energy-intensive, and these devices may require batteries to operate.

One solution to this issue is to use a distributed fiber-optic sensor. This DFOS technology advantageously converts an optical fiber extending over 10 kilometers into a distributed sensor with a spatial resolution on the order of 1 meter. Specifically—as noted above—a sensor employing phase-sensitive optical time-domain reflectometry (Phase-sensitive OTDR), also known as a Distributed Acoustic Sensor (DAS), can convert mechanical dynamic strains on the fiber, caused by acoustic signals, into phase changes in Rayleigh backscattered light. Consequently, this allows for the monitoring of local acoustic events over very large geographic areas using the optical fiber. Of further advantage, the optical fiber may be a telecommunications-carrying optical fiber, thereby allowing telecommunications traffic and DFOS—simultaneously.

As noted, rainfall detection and rainfall intensity monitoring are crucial functions for a wide range of societal, scientific, and industrial applications and/or functions, such as transportation, agriculture, water management, weather forecasting, and building energy estimation. Currently, the collection of rainfall intensity data primarily uses land-based weather stations and Earth orbiting satellites. However, these methods are subject to limitations in terms of availability and accessibility.

As climate change leads to more frequent and intense extreme precipitation events, there is an urgent need for improved methods to measure rainfall intensity accurately. This urgency highlights the imperative to innovate and develop sensors that are capable of long-range, wide-coverage rain data collection, thereby enhancing our ability to respond to and manage the impacts of these changes effectively. As we shall show and describe, the present disclosure describes innovative systems, methods, and structures that solve the rain intensity monitoring problem noted by learning from raw fiber sensing data in the frequency domain.

According to aspects of the present disclosure, we introduce an innovative Distributed Fiber Optic Sensing (DFOS) technology that advantageously utilizes existing telecommunications infrastructure networks. DFOS enables a novel approach to monitor weather conditions and environmental changes, provides real-time, continuous, and precise measurements over large areas and delivers comprehensive insights beyond the visible spectrum. To illustrate our inventive techniques, we explore rain intensity monitoring as an illustrative example for demonstrating the sensing capabilities of our DFOS system.

To enhance the rain sensing performance, we introduce a Deep Phase-Magnitude Network (DFMN), divide raw sensing data into phase and magnitude components, thereby allowing targeted feature learning on each component independently. Furthermore, we introduce a Phase Frequency learnable filter (PFLF) for the phase component filtering and conduct standard convolution layers on the magnitude component, leveraging the inherent physical properties of optical fiber sensing. We formulate the phase-magnitude channel into a parallel network and subsequently fuse the features for a comprehensive analysis in the end. Experimental results on the collected fiber sensing data show that the proposed method performs favorably against the state-of-the-art approaches

We describe a fiber sensing solution and demonstrate rain intensity monitoring as an illustrative example to demonstrate its environmental capabilities. We introduce a Deep Phase-Magnitude Network (DPMN) to separate the raw data into phase and magnitude components, enabling targeted, fine-grained feature learning on each component independently.

According to aspects of the present disclosure, we describe a Phase Frequency Learnable Filter (PFLF) dedicated to filtering a phase component. The PFLF incorporates learnable filters to estimate the scaled dot-product attention of phase and magnitude. Our analysis and experimental results demonstrate that the PFLF module achieves superior performance with lower time complexity.

Finally, we demonstrate that exploring the physical properties of fiber sensing data and analyzing DFOS data in the frequency domain enhances the accuracy of rain monitoring. Our approach shows favorable performance against state-of-the-art methods, indicating its effectiveness and potential for broader environmental sensing applications

Optical fiber networks, serving as the communication backbone, are extensively and densely deployed worldwide. The widespread of optical fiber infrastructures that telecom carriers have constructed over the past 30 years has been designed accommodating the surge in internet traffic and to facilitate the interconnections of 5G and future networks among cities, town, homes, and data centers.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level fiber cable sensor resolution.

We employed a Distributed Acoustic Sensing (DAS) system utilizing OTDR detection. An illustrative DFOS system experimental setup, which comprises a DAS interrogator situated at a central control office, and a fiber cable with one end connected to a DAS to fortify environmental sensing. The DFOS records signals under ambient condition, including environmental noises from traffic, weather, or other events that excite fiber vibrations. The ambient data is continuously captured from more than 1.5 km of aerial fiber cable, at a sampling rate of 5 kHz, and at a spatial resolution of 1.2234 m. In the end, the DAS produces a spatiotemporal matrix storing vibration amplitudes at sampled timestamp and spatial locations. Compared to camera-based imaging, DFOS offers extended coverage for environmental monitoring over long distances and delivers comprehensive information beyond the visible spectrum.

In this disclosure, we present a rain intensity monitoring solution using DFOS technology and deep learning to enhance the environmental perception. Unlike approaches that use images captured from cameras, which are represented as a 2-D matrix with height and width dimensions, raw fiber sensing data is structured as a 2-D matrix where the x-axis represents time and the y-axis denotes location information. We treat this raw fiber sensing data as an image input and custom-design deep learning models specifically tailored for rain monitoring applications. Considering the raw fiber sensing data matrix are complex numbers, we introduce a Deep Phase-Magnitude Network (DFMN) and divide the raw data into phase and magnitude component, enabling targeted feature learning on each component independently.

To capitalize on the inherent physical properties of fiber sensing data, we employ a Phase Frequency Transformer module (PFT) dedicated to filtering the phase component, while conducting standard convolutional layers on the magnitude component. The main contributions of this work are summarized as follows.

We describe a fiber sensing solution and showcase rain intensity monitoring as an illustrative example to demonstrate its environmental perception capabilities. We introduce a Deep Phase-Magnitude Network (DPMN) to separate the raw data into phase and magnitude components, enabling targeted, fine-grained feature learning on each component independently.

We describe a Phase Frequency Learnable Filter (PFLF) dedicated to filtering the phase component. The PFLF module incorporates learnable filters to estimate the scaled dot-product attention of phase and magnitude. Our analysis and experimental results demonstrate that the PFLF module achieves superior performance with lower time complexity.

Finally, we demonstrate that exploring the physical properties of fiber sensing data and analyzing the data in the frequency domain enhances the accuracy of rain monitoring. Our inventive approach shows favorable performance against state-of-the-art methods, indicating its effectiveness and potential for broader environmental sensing applications.

Our goal is to develop an effective and efficient method to explore the properties of frequency domain filtering for accurate rain monitoring and improve the domain generalization for environmental perception. By leveraging the inherent physical properties of DFOS optical fiber sensing data, we employ a Deep Phase-Magnitude Network (DFMN) divide the raw sensing data into phase and magnitude components, advantageously allowing targeted feature learning on each component independently. We describe a Phase Frequency Learnable Filtering module (PFLF) specifically configured for filtering the phase component, while applying standard residual blocks to the magnitude component. We formulate the phase and magnitude branch as parallel networks and eventually merging the features for an integrated analysis.

Different from frequency-based signal or image processing methods that applied in the pixel space or original I-D signals, we employ the proposed frequency filtering operations in the feature latent space. We briefly recall the conventional Fast Fourier Transform (FFT) in signal processing and discuss the characteristics of applying it into latent feature representations.

Given the intermediate features of X e where C, H and W are the channel, height and weight of the input feature X, we perform a 2D Fast discrete Fourier Transform (FFT) to these input features. This process yields the frequency representation X^{F} e. The transformed X^{F} comprises 2C channels, incorporating both the real and imaginary parts. Leveraging the conjugate symmetric property of the FFT. X^{F} only needs retain the half of spatial dimensions thus has spatial resolution H x]+1). We express this FFT operation x^{F}=FFT (X) as below:

$${X}^{F} ( x , y ) = {\sum }_{h = 0} {\sum }_{w = 0} X ( h , w ) {e}^{- j 2 π ( x \frac{h}{H} + y \frac{w}{W} )} . \qquad ( 1 )$$

In the frequency domain, the two primary components of X namely the magnitude component XM and the phase component XP, can be obtained by:

$$xF Re {\{ {x}^{F} \}}^{2} + 1 m {\{ {x}^{F} \}}^{2} ,$$

$$1 m \{ xF \} xp = arctan \{ 3 ) Re \{ xF \}$$

where Re and 1m correspond to the real and imaginary parts of X, Benefiting from the FFT, these two components can capture the feature receptive field easily, which can just meet our need for efficient feature dependency modeling. The frequency representation X can be converted to the original feature space using an inverse FFT. This operation can be expressed as X=iFFT (x^{F}):

$$X ( h , w ) = \frac{h}{H \cdot W} {{\sum }_{h = 0} {\sum }_{w = 0} {X}^{F} ( x , y ) {e}^{- j 2 π ( x \frac{h}{H} + y \frac{w}{W} )}}^{11 - 1 w - 1} .$$

As is known, distinct frequency components of the original feature X are decomposed into elements across different spatial locations of X, which can be regarded as a frequency-based disentanglement and reorganization of X. This property not only makes learning in the frequency domain practically efficient but also facilitates frequency filtering through simple designed learnable filters. An additional benefit is that X serves as a naturally global feature representation, which can facilitate the suppression of globally distributed domain-specific information, such as ambient noise and traffic noise, during data collection of the DFOS system.

The raw fiber sensing data collected from the DFOS system comprise a complex number matrix, where the x-axis represents the range of cable locations, and the y-axis denotes the measurement time. It is important to note that this complex number matrix exists in the time domain, distinguishing it from complex numbers typically encountered in the frequency domain. Previous research on DFOS-based applications has focused exclusively on the phase component of the raw data, leading to the loss of signal intensity information related to the event. Here, we propose a Deep Phase-Magnitude Network (DPMN) designed to integrate both the phase and magnitude components of the data for more comprehensive learning. As we shall show and describe further, DPMN is structured with distinct branches for magnitude and phase.

Given that magnitude and phase represent distinct physical characteristics inherent to the DFOS system, we carefully design different learning modules for each of these two branches to ensure effective feature extraction of each data input. Let S be the raw data matrix collected from DFOS. This matrix can be decomposed into a magnitude response SM=M(S) and phase response Sp=P(S) using Eq. 2 and Eq. 3, where M(•) and P(•) are operations to extract magnitude and phase, respectively.

Our DPMN utilizes standard residual convolutional blocks for feature learning on SM within the time domain, and introduces a learnable filtering module dedicated to Sp in the frequency domain. The raindrop intensity information contained in the magnitude response renders it analogous to a 2-D intensity map, like those encountered in image processing. Thus, we employ residual blocks within this branch to effectively process and analyze the data.

On the other hand, the backscattering signal aberration such as phase leading or lagging caused by the difference locations of acoustic event, are captured by fiber cable and encapsulated within phase response. Correspondingly, we propose a Phase Frequency Learnable Filtering (PFLF) module for phase branch learning. Those two operations can be written as:

XM=ResB10ck(SM),

XP=PFLF(Sp),
where XM and XP represent the feature representations from the two branches, respectively. We merge these learned features into a unified feature representation, denoted as xM, XP). The integrated features contain global features from both magnitude and phase branches, providing a comprehensive representation of the raw fiber sensing data. In the end, the combined feature set is subsequently processed through a final convolutional block, employing a standard cross-entropy loss function to accurately assess the intensity range of the raindrops.

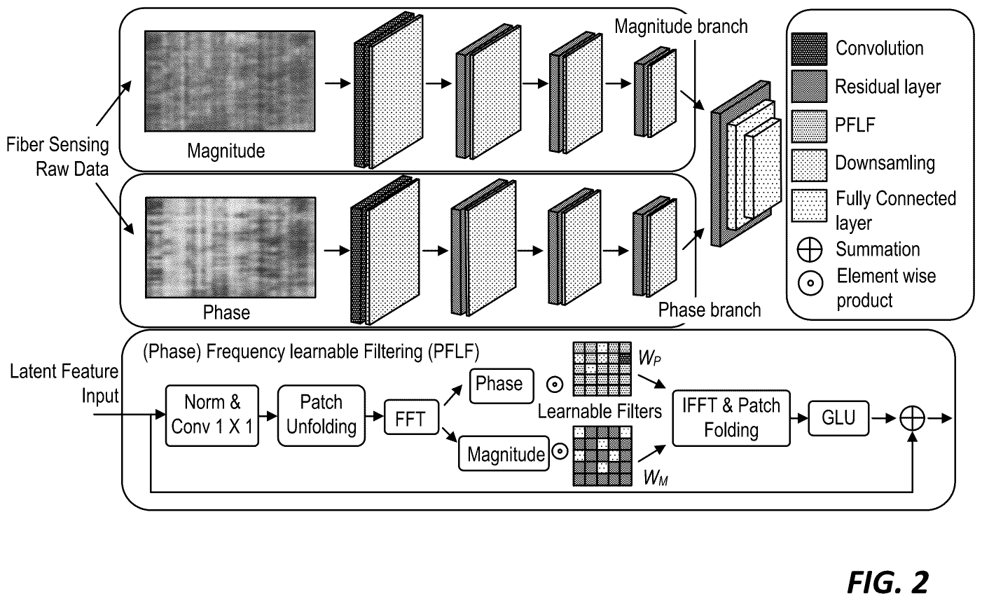

We now introduce the PFLF module for phase response channel, as illustrated in the bottom branch of FIG. 2. Our goal is to adaptively select various frequency components within the feature representation space. We thus propose to employ a frequency learnable filtering on XP, enabling precise manipulation and enhancement of the signal characteristics pertinent to rain monitoring. Given input feature representation XP, we first applied a normalization layer followed by a 1><1 convolution layer, aim to enhance the reusability of feature maps and introduce additional non-linearities across different parts of the network.

This feature pre-processing step can be written as:

XP=(JV(Xp)).

We then apply a patch unfolding on the feature space, transforming the input feature maps into a series of smaller, overlapping patches. This process mainly utilized in vision transformers, allows the model to better exploit the local spatial relationships within the data, and learn more complex and hierarchical features [14, 361. Following the unfolding of feature patches, an FFT operation is applied to transform the phase response into the frequency domain:

x^{F}p=FFT( [symbol] (X̅_{P}).
where P is the patch unfolding operation. To enhance feature learning within the frequency domain, we decompose the frequency response into magnitude and phase using Eq. 2 and Eq. 3. Note this response analysis occurs within the frequency domain, distinguishing from the earlier discussed branch separation of raw fiber sensing data in time domain. Set M (Xp) and P (XP) as the corresponding magnitude and phase, we multiply them element-wise with two learnable quantization matrices wM and wp. Subsequently, we integrate the filtered magnitude and phase responses to reconstruct the frequency domain's complex number matrix.

Finally, we perform inverse FFT and patch folding [symbol] ⁻(O to recover the frequency domain features to time domain:

$${X}_{P}^{′} = 𝒢 ( {𝒫}^{- 1} ( iFFT ( \overline{{X}_{P}^{F}} ) ) ) + {X}_{P} ,$$

where G denotes Gated Linear Unit (GLU) function, we further enhance the process by adding the original input to the output of the frequency filtering, thereby aiming to facilitate more effective and robust feature selection.

FIG. 2 is a schematic diagram showing illustrative overview of our Deep Phase-Magnitude Network (DPMN) according to aspects of the present disclosure.

As illustratively shown in this overview of our Deep Phase-Magnitude Network (DPMN), the DPMN includes a magnitude component channel (top branch in the figure) and a phase component channel (middle branch in the figure).

The magnitude channel is configured to capture amplitude information of raindrops impacting DFOS optical fiber sensor cable, while the phase channel is configured to extract characteristics of how the impact of raindrops is transmitted through the optical fiber sensor cable. As illustratively shown, a Phase Frequency Learnable Filtering (PFLF) module (the bottom branch) dedicated to the phase channel.

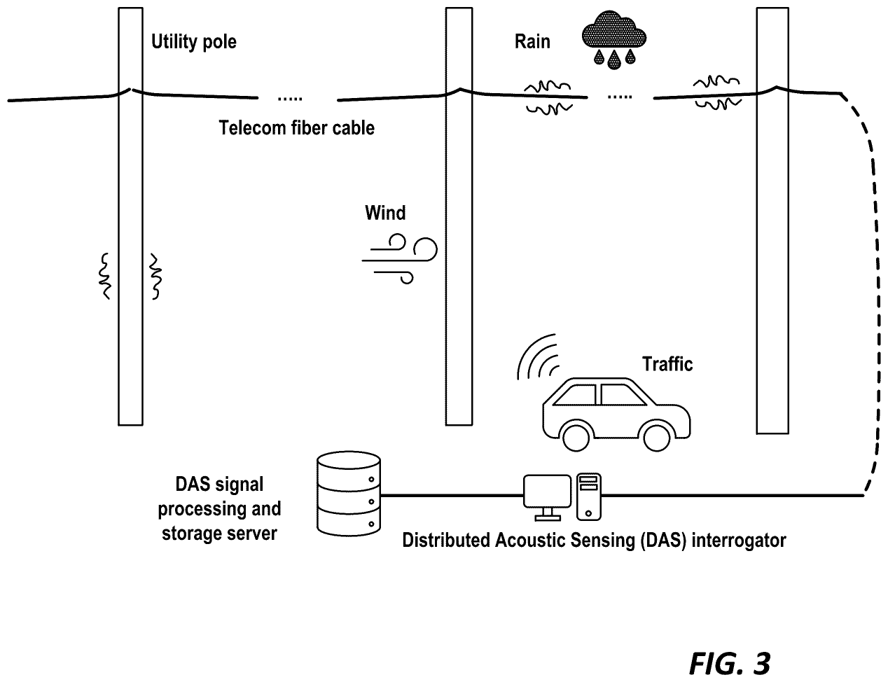

FIG. 3 is a schematic diagram showing illustrative implementation details of our inventive systems, methods, and structures according to aspects of the present disclosure.

As illustratively shown, a Distributed Acoustic Sensing (DAS) interrogator and DAS signal processing and storage server are operationally interconnected to one another and a length of telecommunications fiber cable that as noted may advantageously also serve as an optical fiber sensor cable for the DFOS/DAS. The telecommunications fiber cable is shown as aerially suspended from a number of utility poles and exposed/subjected to environmental conditions including wind, rain, and traffic—among others—as illustratively shown. Those skilled in the art will understand and appreciate that other weather and/or environmental conditions may provide acoustic and/or vibrational impacts to the optical cable and utility poles.

Data collection and labeling. A Distributed Acoustic Sensing system, located at one end of the optical sensor fiber, captures real-time acoustic vibration information impacting along the length of up to tens of kilometers of optical fiber sensor cable with meter-scale spatial resolution. Those skilled in the art will understand and appreciate that recorded raw data require the geographic locations of utility poles to be associated with their DAS locations along the optical fiber sensor cable.

To evaluate our inventive systems, methods, and structures, we performed experimental data collection from field trials of our testbed using DFOS system. The dataset was collected along an optical fiber route spanning over 3,500 meters, with data collection operations running continuously, 24/7. In consideration of the large volume of collected data, we segment the raw data into small data matrices having a size of 512×256.

A ground truth of rain intensity is collected by weather stations that are located along with the fiber cable testbed. We separate the rain intensity into four categories based on the rain rate measured in inches per hour (in/h): Ambient condition (No rain), light rain (0˜0.1 in/h), moderate rain (0.1˜0.3 in/h) and heavy rain (above 0.3 in/h).

We formulate rain monitoring as a classification problem rather than regression due to the discontinuous of the ground truth values from weather stations, particularly noting the presence of numerous missing values during data labeling. We select 5 distinct days, denoted as {D₁, D₂, D₃, D₄, D₅}, which contains all categories of rain intensities. A total of over 8,000 raw data matrices are extracted for model training and evaluation.

To investigate the effectiveness of the PFLF operation, we compare it with baseline ResNet and other frequency filtering solutions Filtered Frequency Compounding (FFC), FSAS, and DFFN. Given that those models are applied across various tasks, we adapt these approaches to our scenario, maintaining an identical number of network layers to accelerate a fair comparison

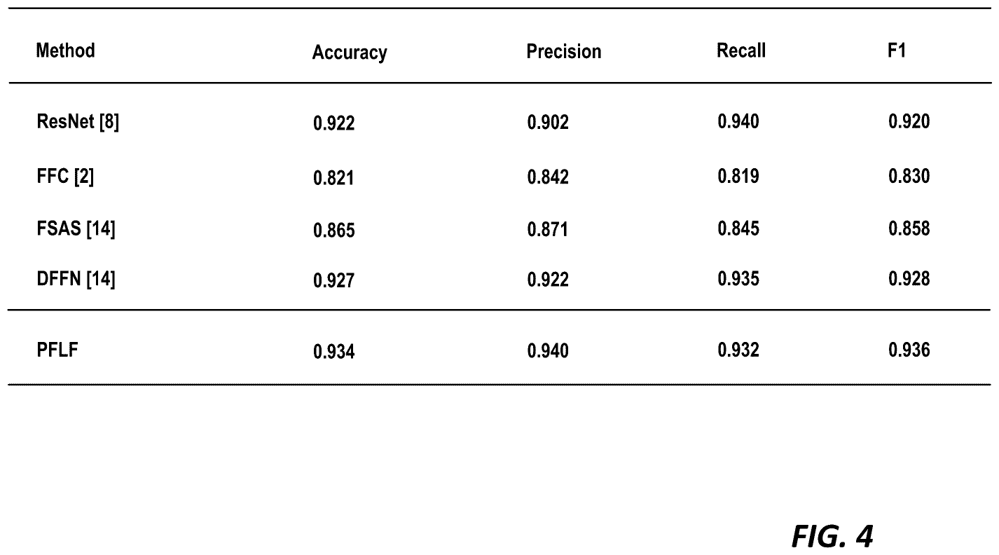

FIG. 4 shows in tabular form a comparison of our inventive Phase Frequency Learnable Filtering (PFLF) module with baseline ResNet and other frequency filtering solutions according to aspects of the present invention.

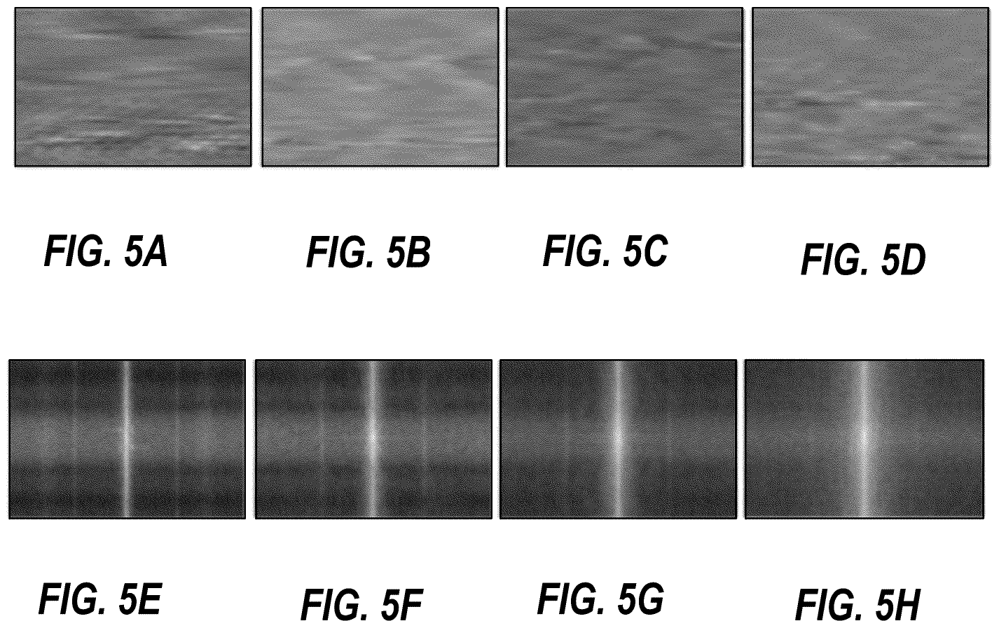

FIG. 5(A), FIG. 5(B), FIG. 5(C), FIG. 5(D), FIG. 5(E), FIG. 5(F), FIG. 5(G), and FIG. 5(E) show a series of plots for the comparisons of FIG. 4 according to aspects of the present disclosure.

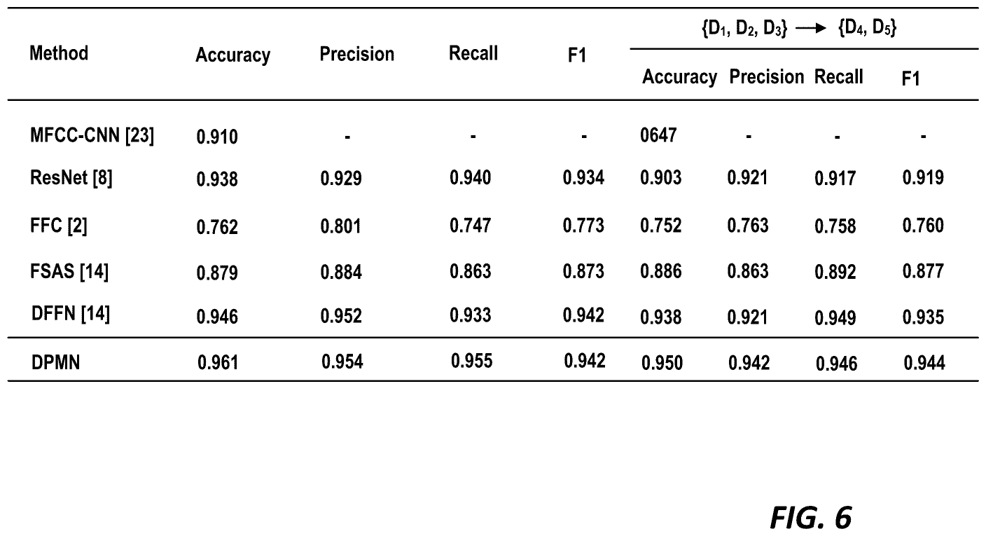

FIG. 6 shows in tabular form illustrative effectiveness of our inventive DPMN model, the results of classification and domain generalization according to aspects of the present invention.

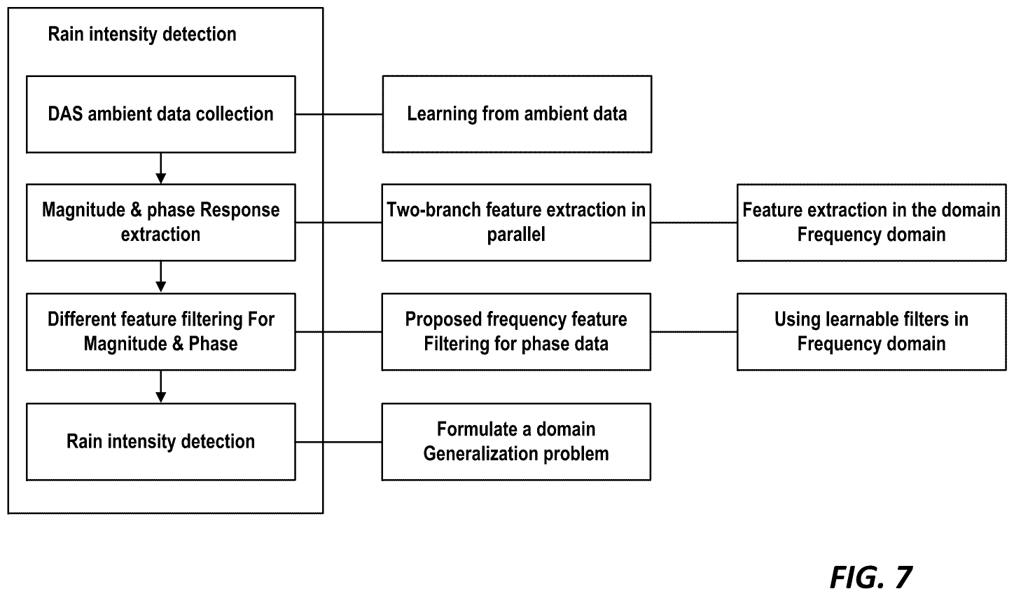

FIG. 7 is a schematic diagram showing illustrative features of systems, methods, and structures according to aspects of the present disclosure.

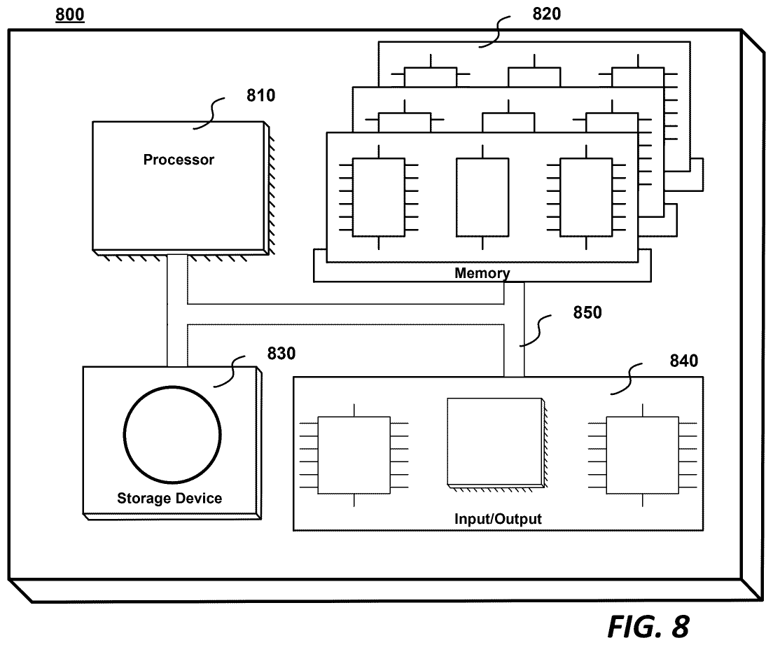

FIG. 8 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 800 as stored program control instructions.

Computer system 800 includes processor 810, memory 820, storage device 830, and input/output structure 840. One or more input/output devices may include a display 845. One or more busses 850 typically interconnect the components, 810, 820, 830, and 840. Processor 810 may be a single or multi core. Additionally, the system may include accelerators etc., further comprising the system on a chip.

Processor 810 executes instructions in which embodiments of the present disclosure may comprise steps described in one or more of the Drawing figures. Such instructions may be stored in memory 820 or storage device 830. Data and/or information may be received and output using one or more input/output devices.

Memory 820 may store data and may be a computer-readable medium, such as volatile or non-volatile memory. Storage device 830 may provide storage for system 800 including for example, the previously described methods. In various aspects, storage device 830 may be a flash memory device, a disk drive, an optical disk device, or a tape device employing magnetic, optical, or other recording technologies.

Input/output structures 840 may provide input/output operations for system 800.

At this point, those skilled in the art will understand and appreciate that we introduce a Deep Phase-Magnitude Network (DFMN) and point out that combining the filtering in time domain and frequency domain can significantly enhance the classification accuracy and improve the domain generalization ability. We divide the raw fiber sensing data into magnitude response and phase response for parallel feature representation learning. Furthermore, we propose a Phase Frequency Learnable Filter (PFLF) specifically designed for phase component learning, which effectively determines the frequency components crucial for enhancing rain detection accuracy. In the end, we formulate the phase-magnitude channel within a dual-path network and subsequently fuse the features for a comprehensive analysis. Extensive experiments and ablation studies demonstrate the effectiveness of our proposed method.

While we have presented our inventive concepts and description using specific examples, our invention is not so limited. Accordingly, the scope of our invention should be considered in view of the following claims.

1. A distributed acoustic sensing (DAS) method comprising:
collecting, using a DAS system, ambient data from an optical sensing fiber;
extracting, magnitude and phase responses from the collected ambient data;
applying, different feature filtering for the extracted magnitude and phase responses; and
determining environmental conditions of the optical sensing fiber from the filtered phase responses.

2. The method of claim 1 wherein the different feature filtering is performed by a deep phase-magnitude network (DPMN).

3. The method of claim 2 wherein the extracted magnitude is filtered by a magnitude component channel configured to capture amplitude information of acoustic events impacting the optical sensing fiber.

4. The method of claim 3 wherein the extracted phase response is filtered by a phase component channel which extracts characteristics of how the acoustic events impacting the optical sensing fiber is conveyed through the optical sensing fiber.

5. The system of claim 4 wherein the phase component channel includes a Phase Frequency Learnable Filter (PFLF) dedicated to filtering the phase component and incorporating learnable filters configured to estimate a scaled dot-product attention of phase and magnitude.
